(19) United States
(12) Patent Application Publication
(10) Pub. No.: US 2023/0058101 A1
(43) Pub. Date: Feb. 23, 2023

(54) Powered Industrial Truck (PIT) with Rear-Loading/Lifting Mechanism

(71) Applicant: Brandon Michael West, Chattanooga, TN (US)

(72) Inventor: Brandon Michael West, Chattanooga, TN (US)

(21) Appl. No.: 17/408,885

(22) Filed: Aug. 23, 2021

(51) Int. Cl. B66F 9/075

(52) U.S. Cl. CPC B66F 9/0759

(57) ABSTRACT

(1) A Powered Industrial Truck (PIT) whereby the driver is positioned facing away from the rear-mounted mast and loading mechanism. This machine increases the operational field of view and awareness of surroundings during extended paths of transit in both warehouse and manufacturing facilities. Cameras, lights, and a dash-mounted display are utilized for assisting the operator with the loading and unloading of materials.

### BACKGROUND OF THE INVENTION

The field of endeavor to which the invention pertains is manufacturing and warehousing. General understanding of a Powered Industrial Truck (PIT) design can reference U.S. Pat. No. 2,675,139A or U.S. Pat. No. 2,554,930A for forward facing lift truck designs.

There is a significant number of safety related incidents involving the operations of pedestrian-mounted motorized hydraulic/geared/pulley lifting devices in manufacturing and warehouse settings. More specifically, incidents involving contact of the PIT with stationary objects, other PITs, or pedestrians. Operators are currently required to drive in reverse if the suspended load of the powered industrial truck obstructs their view in a manner that would cause unsafe driving conditions. Driving in reverse also poses an ergonomic workplace hazard as operators are required to twist at the waist to maintain a proper field of vision during transit.

### BRIEF SUMMARY OF THE INVENTION

A PIT where the lifting mechanism is positioned behind the operator's seat. This design increases safe operations of pedestrian-mounted motorized hydraulic/geared/and pulley lifting devices in manufacturing and warehouse settings by increasing the field of view for the operator while in use. Visibility is also increased due to the driver no longer being required to look through the narrowed passage between the center of the mast during transit.

### BRIEF DESCRIPTION OF DRAWINGS

FIG. 1: Side View of Driver Position on PIT

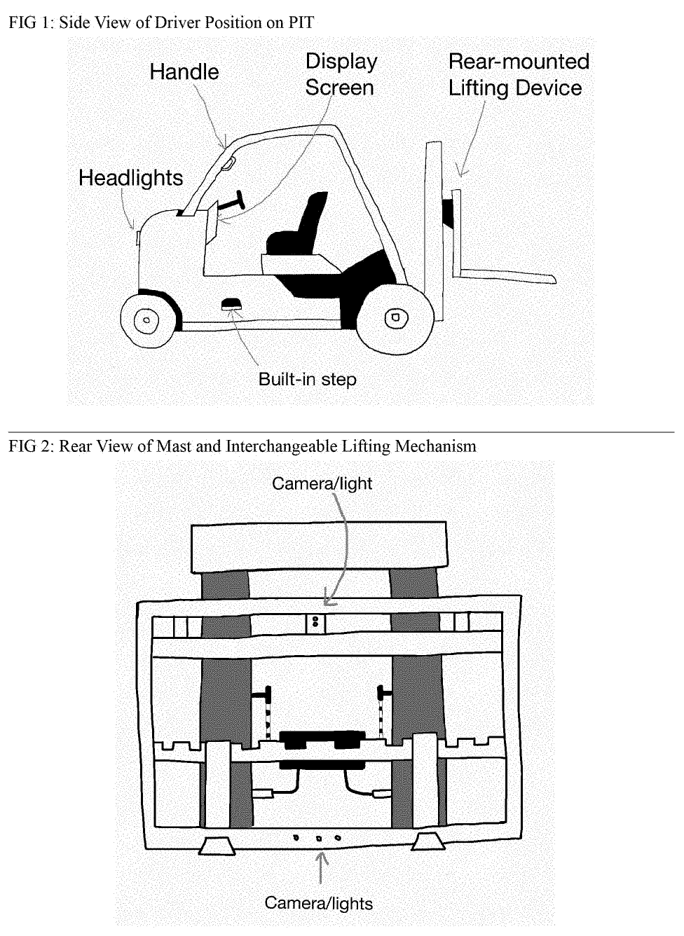

Shows driver position seated facing in opposite direction of lifting mechanism, as opposed to the original design which required the driver to face towards the lifting mechanism. Handle and built-in step are to assist in mounting/dismounting of PIT by the operator. Headlights serve to both illuminate the path of travel for the driver, and to make pedestrians better aware of the presence of the PIT whenever view is obstructed in a warehouse/manufacturing setting. Display screen mounted to dash to show camera views during the loading/unloading of materials on the rear-mounted lifting mechanism.

FIG. 2: Rear View of Mast and Interchangeable Lifting Mechanism

Shows cameras/lights mounted in position at the top and bottom of the mast to assist in loading/unloading of materials.

1. A Powered Industrial Truck (PIT) comprising:
a rear-loading mechanism which is positioned so that the operator is facing away from the elevated load during transit.

2. A Powered Industrial Truck (PIT) as in claim 1, wherein said rear-loading mechanism has interchangeable attachments (e.g. forks, pole(s), clamps, etc.).

3. A Powered Industrial Truck (PIT) as in claim 1, wherein said PIT is capable of all basic lifting functionalities comparable to current front-facing PIT models.

4. A Powered Industrial Truck (PIT) as in claim 1, wherein said PIT is capable of the same rated capacity as comparable front-facing PIT models.

5. A Powered Industrial Truck (PIT) as in claim 1, wherein said rear-loading mechanism has cameras/lights mounted on the top and bottom center of the mast to assist with the loading/unloading processes.

6. A Powered Industrial Truck (PIT) as in claim 1, wherein said PIT has a dash-mounted display for use with mast cameras/lights operations.

7. A Powered Industrial Truck (PIT) as in claim 1, wherein said PIT has headlights mounted to the front for increased visibility during transit.
